(19) United States
(12) Patent Application Publication
(10) Pub. No.: US 2010/0040033 A1
(43) Pub. Date: Feb. 18, 2010

(54) REVERSE DIRECTION GRANT (RDG) FOR WIRELESS NETWORK TECHNOLOGIES SUBJECT TO COEXISTENCE INTERFERENCE

(75) Inventors: Ariton E. XHAFA, Plano, TX (US); Yanjun SUN, Richardson, TX (US); Xiaolin LU, Plano, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/541,339

(22) Filed: Aug. 14, 2009

Related U.S. Application Data
(60) Provisional application No. 61/088,842, filed on Aug. 14, 2008.

(51) Int. Cl. H04W 84/02; H04B 15/00

(52) U.S. Cl. 370/338; 455/552.1

(57) ABSTRACT

In accordance with at least some embodiments, a system includes an access point and a station in communication with the access point. The station has at least two network technology subsystems subject to coexistence interference. The station selectively uses reverse direction grant (RDG) for communications by network technology subsystems subject to coexistence interference.

### CROSS-REFERENCE TO RELATED APPLICATIONS

This application is a non-provisional application claiming priority to provisional application Ser. No. 61/088,842, filed on Aug. 14, 2008, entitled “Novel Approach To Improve Coexistence Of Wireless Networks,” the teachings of which are incorporated by reference herein.

### BACKGROUND

Next generation mobile devices implement a plurality of wireless technologies to access different networks such as WiMAX networks, WLAN networks, LTE networks, Wireless USB or Bluetooth (BT) networks, etc. Such devices are referred to herein as “combo” devices. While increased access to these technologies benefit users and operators alike, interference among different technologies, particularly onboard a single combo device, introduces difficulties during concurrent operation of these technologies. For example, and as illustrated in FIG. 1, WLAN (in 2.4-2.5 GHz) and WiMAX (2.3-2.4 GHz and 2.5-2.7 GHz) technologies operate at relatively close frequency bands with respect to each other—so close, in fact, that the out-of-band emission by either technology may saturate the receiver of the other technology resulting in potential blocking. Thus, the interference between different technologies operating in the same combo device creates coexistence problems.

To solve the coexistence problem, in which WLAN technology is one of the subsystems operating in the same combo device, time multiplexed operations have been proposed. As an example, in the case of WLAN and BT coexistence, BT voice calls take priority over other traffic flows in WLAN. During the time periods that the device operates in BT mode, the WLAN operates in unscheduled automatic power saving delivery (U-APSD) mode. During the time that the combo device operates in WLAN mode, a trigger frame (or a PS-Poll) is sent to the access point (AP) to indicate the combo device is ready to receive packets. If the packets addressed to the combo device are sent within the time period that the combo device is operating in WLAN mode, collisions are avoided. However, if the combo device is not able to reply with an ACK (in case of immediate acknowledgment) or if the packets sent by the AP are not sent within the time interval that the combo device operates in WLAN mode, collisions occur and a rate-fall back mechanism is triggered. The rate-fall back mechanism reduces the transmission rate used to send packets from the AP to the combo device. With reduced transmission rates, packets transmitted over the air occupy longer intervals and are likely to result in increased collisions with BT mode transmissions. Therefore, the performance of the combo device in BT and WLAN mode further deteriorates resulting in what is referred to as the “avalanche effect”.

One way to prevent the avalanche effect would be to enable the AP to participate in a Request to Send/Clear to Send (RTS/CTS) handshake with a WLAN/BT combo device before data transmissions. However, this technique requires changes to AP implementation. Another way to prevent the avalanche effect is to configure the combo device transmit a CTS2Self frame. The network allocation vector (NAV) for the CTS2Self frame may be arranged to protect WLAN as well as BT transmissions. However, the use of CTS2Self frames silences other devices in the WLAN network; hence, reducing the overall performance of the network. There is a need for a new approach to avoid the avalanche effect in combo devices.

### SUMMARY

In accordance with at least some embodiments, a system comprises an access point and a station in communication with the access point. The station has at least two network technology subsystems subject to coexistence interference. The station selectively uses reverse direction grant (RDG) for communications by network technology subsystems subject to coexistence interference.

In at least some embodiments, a communication device comprises a transceiver with a first wireless technology subsystem and a second wireless technology subsystem, the first and second wireless technology subsystems being subject to coexistence interference. To avoid an avalanche effect, the transceiver comprises arbitration logic that manages reverse direction grant (RDG) requests for communications by at least one of the first and second wireless technology subsystems.

In at least some embodiments, a method comprises providing a transceiver with a first wireless technology subsystem and a second wireless technology subsystem, the first and second wireless technology subsystems being different. The method also comprises arbitrating reverse direction grant (RDG) communications for the first and second wireless technology subsystems to avoid an avalanche effect.

### BRIEF DESCRIPTION OF THE DRAWINGS

For a detailed description of exemplary embodiments of the invention, reference will now be made to the accompanying drawings in which:

FIG. 1 illustrates different network technologies and their operating bands;

FIG. 2 illustrates an example wireless local area network (WLAN) in accordance with an embodiment of the disclosure;

FIG. 3 illustrates an exemplary access point and/or wireless device in accordance with an embodiment of the disclosure;

FIG. 4 illustrates a simplified communication device in accordance with an embodiment of the disclosure;

FIG. 5 shows a High Throughput (HT) control field having Reverse Direction Grant (RDG) control bits in accordance with an embodiment of the disclosure;

FIG. 6A shows a timing diagram for a combo device granting a transmission opportunity (TXOP) to an access point (AP) in accordance with an embodiment of the disclosure;

FIG. 6B shows a timing diagram for a combo device granting an RDG to an access point (AP) in accordance with an embodiment of the disclosure;

FIG. 7 shows a flowchart implemented by arbitration logic of a communication device in accordance with an embodiment of the invention; and

FIG. 8 shows a method in accordance with an embodiment of the disclosure.

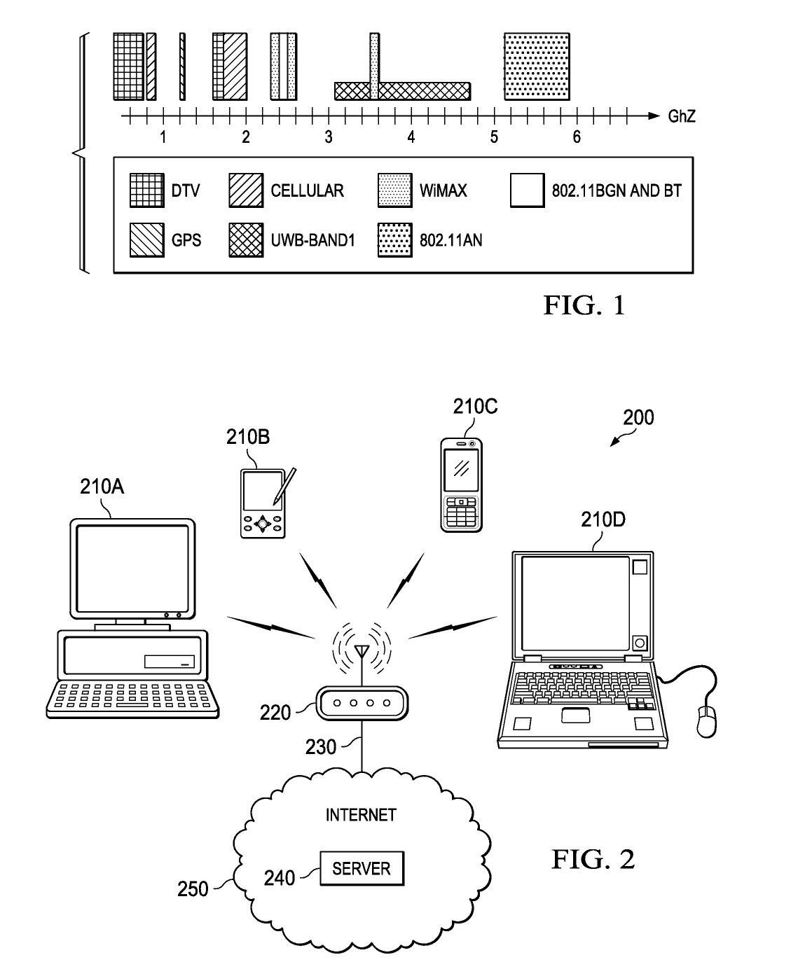

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct electrical connection. Thus, if a first device couples to a second device, that connection may be through a direct electrical connection, or through an indirect electrical connection via other devices and connections. The term “system” refers to a collection of two or more hardware and/or software components, and may be used to refer to an electronic device or devices or a sub-system thereof. Further, the term “software” includes any executable code capable of running on a processor, regardless of the media used to store the software. Thus, code stored in non-volatile memory, and sometimes referred to as “embedded firmware,” is included within the definition of software.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Embodiments of the disclosure are directed to communication systems having at least one “combo” device (i.e., a device having at least two dissimilar network technology subsystems that are subject to coexistence interference). As used herein, “coexistence interference” refers to interference that occurs during simultaneous emissions (e.g., out-of-band emissions by either technology may saturate the receiver of the other technology resulting in potential blocking). To avoid the avalanche effect in the combo device, a reverse direction grant (RDG) scheme is employed. More specifically, embodiments of the disclosure use RDG to avoid rate-fall back and the avalanche effect without using CTS2Self frames, which may lower the overall performance of a network to which the combo device belongs. In some situations, RDG employment in a combo device is constrained by fixed TXOP boundaries (durations) for the dissimilar network technology subsystems. In those situations, RDG is employed if possible, but priority is given to maintaining fixed TXOP boundaries. In other situations, RDG employment in a combo device is assured (or is extended) by adjusting TXOP boundaries.

FIG. 2 illustrates a wireless local area network (WLAN) 200 in accordance with an embodiment of the disclosure. To provide wireless data and/or communication services (e.g., telephone services, Internet services, data services, messaging services, instant messaging services, electronic mail (email) services, chat services, video services, audio services, gaming services, etc.), the WLAN 200 comprises an access point (AP) 220 and any of a variety of fixed-location and/or mobile wireless devices or stations (STAs) (referred to individually herein as device, station, STA or device/station), four of which are respectively designated in FIG. 2 with reference numerals 210A, 210B, 210C and 210D. It should be appreciated that the network 200 is meant to be illustrative and not exhaustive. For example, it should be appreciated that more, different or fewer communication systems, devices and/or paths may be used to implement embodiments. Exemplary devices 210 include any variety of personal computer (PC) 210A with wireless communication capabilities, a personal digital assistant (PDA) or MP3 player 210B, a wireless telephone 210C (e.g., a cellular phone, a smart phone, etc.), and a laptop computer 210D with wireless communication capabilities. At least one of AP 220 and STAs 210A-210D are preferably implemented in accordance with at least one wired and/or wireless communication standard (e.g., from the IEEE 802.11 family of standards). Further, at least one device 210 comprises a combo device with a plurality of wireless network technology subsystems onboard.

In the example of FIG. 2, to enable the plurality of devices/STAs 210A-210D to communicate with devices and/or servers located outside WLAN 200, AP 220 is communicatively coupled via any of a variety of communication paths 230 to, for example, any of a variety of servers 240 associated with public and/or private network(s) such as the Internet 250. Server 240 may be used to provide, receive and/or deliver services such as data, video, audio, telephone, gaming, Internet, messaging, electronic mail, or other services. Additionally or alternatively, WLAN 200 may be communicatively coupled to any of a variety of public, private and/or enterprise communication network(s), computer(s), workstation(s) and/or server(s) to provide any of a variety of voice service(s), data service(s) and/or communication service(s).

In the wireless local area network 200, each device/station (STA) 210A-210D contends for the medium. Once the medium is won, then the winning device/STA has the opportunity to transmit for a duration of time, which in IEEE 802.11 technology is called transmission opportunity (TXOP). Thus, during each TXOP, the winning device/STA has the right to transmit data (or other packets) to another STA (usually the AP). If the winning device/STA has no more data to transmit, then the remaining TXOP duration is “wasted” (i.e., not used by other STAs because they are not the owner of this TXOP). Reverse direction grant (RDG) may be used to circumvent this “wasted” TXOP time. To perform an RDG, the TXOP owner indicates to another device/STA that the TXOP owner is granting the receiving device/STA the use of the remaining TXOP duration. The TXOP owner also may relieve the receiving device/STA from transmitting a packet belonging to a particular access category (AC). Upon decoding the RDG grant from the TXOP owner, the receiving device/STA may start transmitting a data packet (or any other packet, depending on AC constraints) to the original TXOP owner.

When traffic flows are from the access point 220 to a STA, the STA may be in unscheduled power save mode (UPSD). In this mode, the STA wakes up only to receive the beacons from the AP 220. If the AP 220 has data queued for the STA, an indication of the queued data is provided in the beacon. Thus, the STA can determine that there is no queued data at the AP 220 by inspection of the beacon. In such case, the STA goes to sleep until the next beacon transmission time. If there are data packets queued at the AP 220 as indicated by the beacon, the STA stays awake and sends a power save (PS)-Poll to indicate to the AP 220 that the STA is ready to receive the data packets. The AP 220 replies to the PS-Poll with an acknowledgment (ACK) frame, and after a random amount of time (and contending for the channel), the AP 220 sends the data packet which has been queued for the STA. For combo devices, a mode switch may occur such that the transmission of a data packet from the AP 220 or the reception of an ACK from the combo device according to a first wireless technology mode (e.g., during a WLAN mode) overlaps with transmissions of a second wireless technology mode (e.g., during a Bluetooth mode). In other words, the combo device may switch back and forth between different wireless technology modes such as WLAN and Bluetooth. To prevent rate-fall back and/or the avalanche effect from occurring, RDG employment in a combo device is constrained by fixed TXOP boundaries (durations) for the dissimilar network technology subsystems. Alternatively, RDG employment in a combo device is assured (or is extended) by adjusting TXOP boundaries. In other words, the TXOP boundaries may be adjusted to enable effective RDG use in a combo device.

Using RDG, a combo device is able to indicate to the AP 220 that a PS-Poll frame (or a Quality of Service (QoS)-Null frame) is the last frame that the combo device has to transmit and the remaining TXOP is for the AP 220 to use. Giving the remaining TXOP to the AP 220 avoids the slow response from the AP (waiting and contending for the channel). Furthermore, the combo device is able to estimate the time required for the AP 220 to transmit the data and receive the ACK, hence, the combo device may select the TXOP duration accordingly. If the time to transmit the PS-Poll frame (or a QoS-Null frame) is so short that the AP 220 will not be able to transmit the data packet and receive the ACK on time, the combo device may choose not to send the PS-Poll/QoS-Null packet. In such case, the AP 220 will not send the data to the combo device (since the AP 220 did not receive an indication that the combo device is awake); and hence, the avalanche effect is avoided. To summarize, during operations of the WLAN 200, a combo device eventually becomes the TXOP owner. TXOP durations for each wireless technology subject to coexistence interference in a combo device may be based on RDG-independent criteria or RDG-dependent criteria. For TXOP durations based on RDG-independent criteria, RDG use either fits within predetermined TXOP durations or is not used. For TXOP durations based on RDG-dependent criteria, RDG use is assured since the TXOP duration accounts for RDG use.

In accordance with at least some embodiments, a TXOP owner is able to make an RDG request to a receiving device/STA by transmitting a high throughput (HT) control field having RDG control bits. In some embodiments, the HT control field described herein is compatible with IEEE 802.11n packets. Thus, the RDG scheme employed herein is also compatible with the IEEE 802.11n standard. However, the specific examples described herein are not intended to limit embodiments to any particular specification or implementation.

FIG. 5 shows an HT control field 500 having RDG control bits 510 in accordance with an embodiment of the disclosure. As shown, the HT control field 500 comprises 32 bits (4 bytes). Bits 0-15 are for link adaption and antenna selection. Bits 16-23 are for calibration control. More specifically, bits 16-17 are for calibration position; bits 18-19 are for calibration sequence; bits 20-21 are for feedback request; and bits 22-23 are for channel state information (CSI)/steering. As shown, bit 24 is for zero length field (ZLF) announce and bits 25-29 are reserved bits. Bits 30-31 are the RDG control bits 510 and respectively comprise an AC constraint bit and an RDG/more PPDU bit.

In accordance with at least some embodiments, one of the STAs 210A-210D is a combo device that transmits the HT control field 500 to the AP 220 to make an RDG request to the AP 220. As an example, the HT control field 500 may be transmitted to a receiving STA or AP using a PS-Poll. Alternatively, the HT control field 500 may be transmitted to a receiving STA or AP using a QoS-Null frame. Alternatively, the HT control field 500 may be transmitted to a receiving STA or AP using a data frame.

If possible, the TXOP duration is selected for compatibility with RDG requests. In other words, the TXOP duration for a combo device may be selected to ensure that a receiving STA or AP, in response to the RDG, has time to transmit an acknowledgement regarding the RDG and at least one MAC protocol data unit (MPDU) before a network technology mode switch occurs at the combo device. If a combo device determines that a TXOP duration does not provide sufficient time to transmit the HT control field 500 and to receive at least one data packet back from a receiving STA or AP, the combo device avoids transmitting the HT control field 500 and possibly the frame carrying the HT control field.

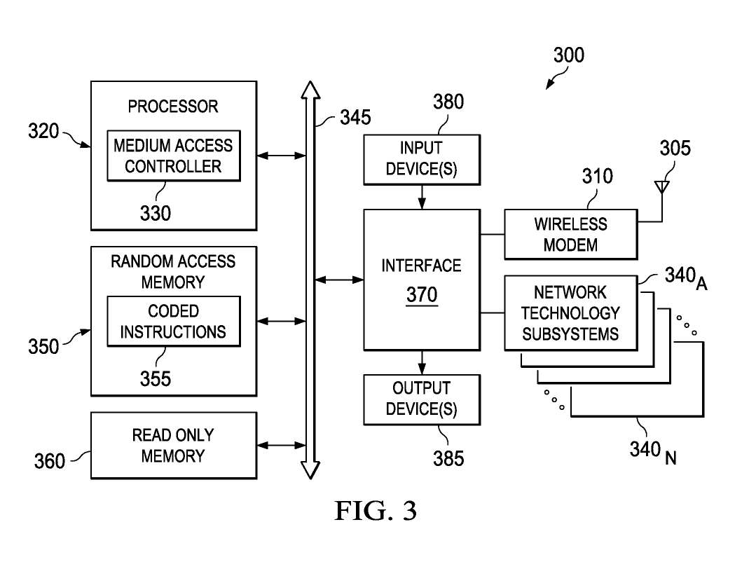

The techniques described herein may be implemented on any general-purpose computer with sufficient processing power, memory resources, and network throughput capability to handle the necessary workload placed upon it. FIG. 3 illustrates a device 300 comprising an exemplary general-purpose computer system that may correspond to a combo device that uses RDG requests. In FIG. 3, the device 300 may be, for example, an access point or other wireless device. It should be expressly understood that any device on, for example, WLAN 200 or other embodiments, may at times be an access point and at other times be a station. It should also be understood that in some embodiments, there may be at least one dedicated access point, with any number of devices acting as stations.

As shown, the device 300 comprises at least one of any of a variety of radio frequency (RF) antennas 305 and any of a variety of wireless modems 310 that support wireless signals, wireless protocols and/or wireless communications (e.g., according to IEEE 802.11n). RF antenna 305 and wireless modem 310 are able to receive, demodulate and decode WLAN signals transmitted in a wireless network. Likewise, wireless modem 310 and RF antenna 305 are able to encode, modulate and transmit wireless signals from device 300 to other devices of a wireless network. Thus, RF antenna 305 and wireless modem 310 collectively implement the “physical layer” (PHY) for device 300. It should be appreciated that device 300 is communicatively coupled to at least one other device and/or network (e.g., a local area network (LAN), the Internet 250, or other devices). It should further be understood that illustrated antenna 305 represents one or more antennas, while the illustrated wireless modem 310 represents one or more wireless modems.

The device 300 further comprises processor(s) 320. It should be appreciated that processor 320 may be at least one of a variety of processors such as, for example, a microprocessor, a microcontroller, a central processor unit (CPU), a main processing unit (MPU), a digital signal processor (DSP), an advanced reduced instruction set computing (RISC) machine, an (ARM) processor, etc. Processor 320 executes coded instructions 355 which may be present in a main memory of the processor 320 (e.g., within a random-access memory (RAM) 350) and/or within an on-board memory of the processor 320. Processor 320 communicates with memory (including RAM 350 and read-only memory (ROM) 360) via bus 345. RAM 350 may be implemented by dynamic RAM (DRAM), synchronous dynamic RAM (SDRAM), and/or any other type of RAM device. ROM 360 may be implemented by flash memory and/or any other type of memory device.

Processor 320 implements MAC 330 using one or more of any of a variety of software, firmware, processing thread(s) and/or subroutine(s). MAC 330 provides medium access controller (MAC) functionality and further implements, executes and/or carries out functionality to facilitate, direct and/or cooperate in avoiding avalanche effect. In accordance with at least some embodiments, the MAC 330 avoids the avalanche effect by employing a reverse direction grant (RDG) scheme. For TXOP durations based on RDG-independent criteria, RDG use controlled by the MAC 330 either fits within predetermined TXOP durations or is not used. For TXOP durations based on RDG-dependent criteria, RDG use controlled by the MAC 330 is assured since the TXOP duration accounts for RDG use. The MAC 330 is implemented by executing one or more of a variety of software, firmware, processing thread(s) and/or subroutine(s) with the example processor 320. Further, the MAC 330 may be, additionally or alternatively, implemented by hardware, software, firmware or a combination thereof, including using an application specific integrated circuit (ASIC), a programmable logic device (PLD), a field programmable logic device (FPLD), discrete logic, etc.

The device 300 also preferably comprises at least one input device 380 (e.g., keyboard, touchpad, buttons, keypad, switches, dials, mouse, track-ball, voice recognizer, card reader, paper tape reader, etc.) and at least one output device 385 (e.g., liquid crystal display (LCD), printer, video monitor, touch screen display, a light-emitting diode (LED), etc.)—each of which are communicatively connected to interface 370.

As shown, interface 370 also communicatively couples a wireless modem 310 with the processor 320 and/or the MAC 330. Interface 370 provides an interface to, for example and not by way of limitation, Ethernet cards, universal serial bus (USB), token ring cards, fiber distributed data interface (FDDI) cards, network interface cards, wireless local area network (WLAN) cards, or other devices that enable device 300 to communicate with other devices and/or to communicate via Internet 250 or intranet. With such a network connection, it is contemplated that processor(s) 320 would be able to receive information from at least one type of network technology and/or output information to at least one type of network technology in the course of performing the herein-described processes. It should be appreciated that interface 370 may implement at least one of a variety of interfaces, such as en external memory interface, serial port, communication internal to device 300, general purpose input/output (I/O), etc.

As shown in FIG. 3, the device 300 comprises network technology subsystems 340_{A}-340_{N}, where N is the number network technology subsystems in device 300. In accordance with embodiments, device 300 comprises at least two dissimilar network technology subsystems 340. As a result, device 300 is said to have coexisting network technologies. “Dissimilar” is used in this context to mean that at least one of the subsystems 340 is from a different network technology than another one of the subsystems 340. It should be understood that some embodiments of subsystems 340 may have their own dedicated wireless modem and antenna, while other embodiments may share either or both of a wireless modem and antenna. Examples of network technologies that may be represented by such subsystems include, but are not limited to, worldwide interoperability for microwave access (WiMAX) networks, wireless local area network (WLAN) networks, long term evolution (LTE) mobile telephony networks, personal area networks (PANs), wireless universal serial bus (USB) networks, BLUETOOTH (BT) networks, ZigBee/IEEE 801.15.4, etc. In accordance with embodiments, processor 320 interacts with network technology subsystems 340 via interfaces implemented by interface 370. It should be appreciated that, for the ease of illustration, only two or three such network technologies may be discussed in connection with any particular embodiment. However, the techniques described herein apply equally to devices having other amounts of technologies onboard a device.

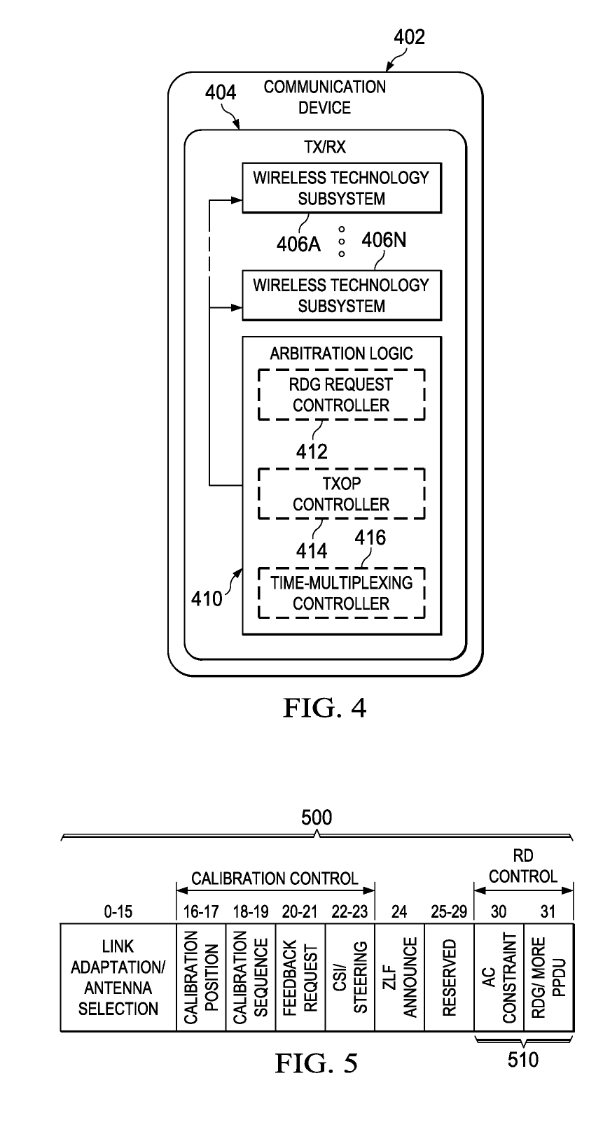

FIG. 4 illustrates a simplified communication device 402 in accordance with an embodiment of the disclosure. The communication device 402 is representative of a combo device as described herein. As shown, the communication device 402 comprises a transceiver (TX/RX) 404 having a plurality of wireless technology subsystems 406A-406N. At least two of the wireless technology subsystems 406A-406N operate at relatively close or overlapping frequency bands with respect to each other such that coexistence interference occurs during simultaneous emissions (e.g., out-of-band emissions by either technology may saturate the receiver of the other technology resulting in potential blocking). To compensate for such coexistence interference and to avoid the avalanche effect, the transceiver 404 comprises arbitration logic 410 to arbitrate the operations of any wireless technology subsystems 406A-406N subject to coexistence interference. As shown, the arbitration logic 410 comprises an RDG request controller 412, a TXOP controller 414 and a time-multiplexing controller 416. The arbitration logic 410 may be implemented, for example, by a media access control (MAC) layer of the transceiver 404.

In accordance with at least some embodiments, the RDG request controller 412 determines whether to use RDG with the communication device 402. The RDG request controller 412 also may determine how much data can be transmitted during an RDG period. The RDG request controller 412 also may request an adjustment to the TXOP duration managed by the TXOP controller 414 and/or time-multiplexing managed by the time-multiplexing controller 416. In at least some embodiments, the RDG request controller 412 causes the transceiver 404 to selectively transmit an HT control field having RDG control bits to make an RDG request. As an example, the RDG request controller 412 may cause the transceiver 404 to transmit the HT control field using a PS-Poll. Alternatively, the RDG request controller 412 may cause the transceiver 404 to transmit the HT control field using a QoS-Null frame. Alternatively, the RDG request controller 412 may cause the transceiver 404 to transmit the HT control field using a data frame.

Meanwhile, the TXOP controller 414 is configurable to set the TXOP duration of any wireless technology subsystems 406A-406N subject to coexistence interference. The TXOP duration may be set based on predetermined time-multiplexing constraints, requests from the RDG request controller 412, requests for TXOP communications, or combinations thereof. The prioritization of the time-multiplexing constraints, RDG requests, and TXOP requests may vary. Meanwhile, the time-multiplexing controller 416 is configurable to set time-multiplexing periods for any wireless technology subsystems 406A-406N subject to coexistence interference. The time-multiplexing periods may be set based on predetermined Quality of Service (QoS) parameters, requests from the RDG request controller 412, requests for TXOP communications, or combinations thereof. In some embodiments, QoS parameters have priority over RDG requests. However, if there are no QoS parameters (or the QoS parameters permit adjustments), then the RDG request controller 412 may send information to the time-multiplexing controller 416 to ensure that RDG use for any wireless technology subsystems 406A-406N subject to coexistence interference is possible or is extended.

In part, RDG relies on the occurrence of TXOPs. Accordingly, the RDG request controller 412 may communicate with the TXOP controller 414 to request TXOPs for RDG use with wireless technology subsystems 406A-406N subject to coexistence interference even if TXOPs would not otherwise be needed. Additionally, the RDG request controller 412 may communicate with the TXOP controller 414 to extend RDG use by extending TXOP durations. As previously noted, the operations of the RDG request controller 412 and the TXOP controller 414 may be subject to time-multiplexing constraints as managed by the time-multiplexing controller 416.

In at least some embodiments, the TXOP controller 414 causes the transceiver 404 to request a TXOP duration that ensures another device, in response to an RDG request, has time to transmit an acknowledgement (ACK) regarding the RDG and at least one data packet (and to receive an ACK if immediate ACK is used) before a mode switch occurs between the first and second wireless technology subsystems. The TXOP controller 414 also may determine that a TXOP duration does not provide sufficient time for the transceiver 404 to transmit an RDG request and to receive at least one data packet back from another device before a mode switch occurs between the first and second wireless technology subsystems. In such case, the TXOP controller 414 may direct the transceiver 404 to not transmit an RDG request.

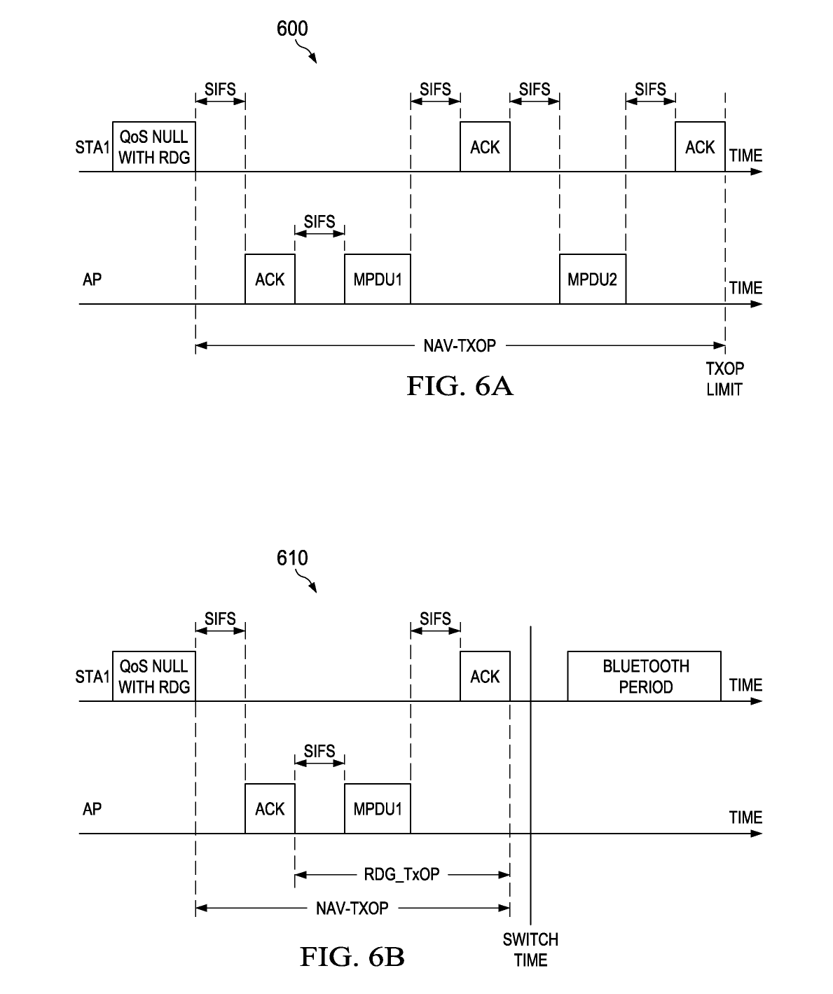

FIG. 6A shows a timing diagram 600 for a combo device granting a TXOP to an AP in accordance with an embodiment of the disclosure. As shown, a station (STA1) transmits a QoS-Null frame with RDG control bits to set up a network allocation vector (NAV)-TXOP for the AP. During the NAV-TXOP period, the AP transmits an ACK (regarding the QoS-Null frame) and a MAC protocol data unit (MPDU1) to STA1. Subsequently, STA1 transmits an ACK (regarding MPDU1) to the AP. The AP then transmits another MPDU (MPDU2) to STA1, which responds with an ACK before the TXOP limit is reached. As shown, each ACK and MPDU may be preceded by a short interframe space (SIFS).

In the embodiment of FIG. 6A, STA1 selectively operates in WLAN mode and Bluetooth mode. Assuming that the TXOP reserved by the QoS-Null frame (or a PS-Poll frame) does not overlap with Bluetooth transmissions, STA1 indicates in the QoS-Null frame that that AP should start transmitting data after sending the ACK. After receiving the QoS-Null frame, the AP determines that the remaining TXOP is loaned to the AP, and hence transmits the MPDU1 and MPDU2 data packets. Although FIG. 6A illustrates that two MPDU transmissions occur, the NAV-TXOP period could allow for one or more MPDU transmissions. If the NAV-TXOP period is insufficient for a single data/ACK (e.g., MPDU1 plus its corresponding ACK) before Bluetooth transmission occurs, then the QoS-Null frame with RDG control bits may not be sent. The next time that the combo device (STA1) has an opportunity to operate in WLAN mode, the procedure of FIG. 6A is repeated. In some embodiments, STA1 is able to request a longer TXOP and thus the NAV-TXOP period can be extended as well.

FIG. 6B shows a timing diagram 610 for a combo device granting an RDG to an AP in accordance with an embodiment of the disclosure. In FIG. 6B, the TXOP value (or NAV-TXOP) is set such that the transmission from the AP to STA1 (which may include an ACK being transmitted from STA1) occurs before a SwitchTime value. After the SwitchTime, STA1 switches to Bluetooth and operates in Bluetooth mode until the end of a Bluetooth period. In a normal operation (e.g., without RDG), a QoS Null frame will set its NAV to cover the corresponding ACK being sent by the AP. If RDG is used, then an RDG_TXOP duration value is added to the NAV. Calculation of the RDG_TXOP duration may be as follows:

$$RDG\_TXOP = Time\_to \_tx \_MPDU 1 + 2 * SIFS + Time\_to \_tx \_ACK , \\ where Time\_to \_TX \_MPDU 1 = \frac{estimated\_packet \_size \_from \_AP}{estimate\_data \_rate \_from \_AP}$$

The variable “estimated_packet_size_from_AP” may be based on either the last packet size received from the AP belonging to the particular access category for which the RDG is sent, or the average packet size over a period of time (or over a predetermined number of received packets) of this particular access category. Meanwhile, the variable “estimated_data_rate_from_AP” may be based on either the last data rate value used by the AP to transmit to STA1 for the particular access category. In some embodiments, the “estimated_data_rate_from_AP” value may take into account variations (e.g., rate decrease/increase) associated with the AP's rate adaptation/fallback algorithm. The Time_to_tx_ACK duration also may take into account variations associated with the AP's rate adaptation/fallback algorithm. If the time at which RDG_TXOP ends is greater than the time at which SwitchTime starts, then STA1 may decide not to send the RDG request as there is insufficient time to transmit an ACK in response to a whole MPDU sent by the AP.

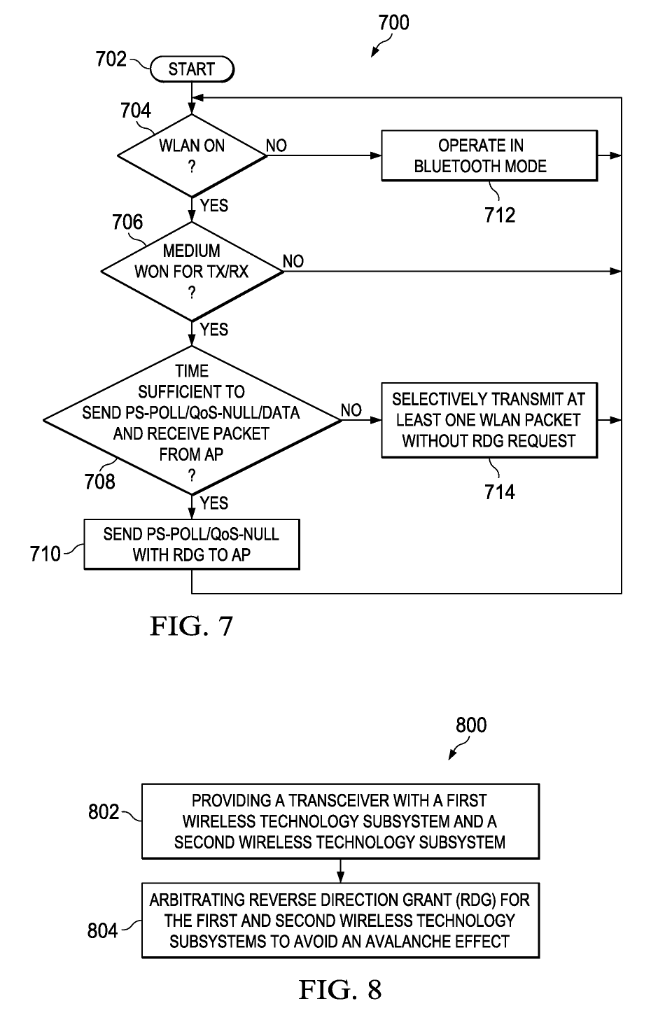

FIG. 7 shows a flowchart 700 implemented by arbitration logic of a combo device in accordance with an embodiment of the invention. In accordance with some embodiments, the arbitration logic 410 of FIG. 4 follows the flowchart 700 to arbitrate time multiplexing for WLAN and Bluetooth. As shown, the flowchart 700 starts at block 702. If WLAN is not on (determination block 704), the combo device operates in Bluetooth mode (block 712) and the flowchart 700 returns to determination block 704. If WLAN is on (determination block 704), the flowchart 700 determines if the medium is won for TX/RX (determination block 706). If the medium is not won (determination block 706), the flowchart 700 returns to determination block 704. If the medium is won (determination block 706), the flowchart 700 determines whether there is sufficient time for RDG use, which may involve sending a PS-Poll frame or a QoS-Null frame with RDG control, sending data to the AP and receiving a packet from the AP (determination block 708). If there is not sufficient time for RDG use (determination block 708), the flowchart 700 comprises selectively transmitting at least one WLAN data packet without an RDG request (e.g., if there is any data in the transmission queue and as time permits) (block 714). After block 714, the flowchart 700 returns to determination block 704. If there is sufficient time for RDG use (determination block 708), the combo device sends an RDG request (e.g., via a PS-Poll frame or QoS-Null frame) to the AP (block 710). The flowchart 700 then returns to decision block 704.

In the case that the combo device has traffic to send to the AP, but there is no traffic from the AP to the combo device, then the combo device does not need to use RDG for the AP. However, if the AP also has packets to send to the combo device, then the first packet sent from the combo device to the AP may have the RDG control bits. The combo device should also take into account whether the AP can send the data packet to the combo device and receive the ACK on time (i.e., before the Bluetooth operation starts). In some situations, the combo device sends a data packet with RDG control bits set instead of sending a PS-Poll frame or QoS-Null frame with RDG control bits set. Although FIG. 7 specifically relates to a combo device with WLAN and Bluetooth modes, it should be understood that other existing or future wireless technologies also may be subject to coexistence interference and thus would benefit from the same arbitration technique.

FIG. 8 shows a method 800 in accordance with an embodiment of the disclosure. As shown, the method 800 comprises providing a transceiver with a first wireless technology subsystem and a second wireless technology subsystem (block 802). The method 800 further comprises arbitrating reverse direction grant (RDG) communications for the first and second wireless technology subsystems to avoid an avalanche effect (block 804).

In accordance with at least some embodiments, the method 800 may comprise additional steps that are added individually or in combination. For example, the method 800 may additionally comprise selectively transmitting a high throughput (HT) control field having RDG control bits to make an RDG request. The method 800 may additionally comprise transmitting at least RDG control bit to configure RDG communications using a power save (PS)-Poll frame, a quality of service (QoS)-Null frame, or a data frame. The method 800 may additionally comprise selecting a TXOP duration to support an RDG request period and an RDG response period before a mode switch between the first and second wireless technology subsystems occurs. The method 800 may additionally comprise avoiding an RDG request if a TXOP duration does not support an RDG request period and an RDG response period before a mode switch between the first and second wireless technology subsystems occurs.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
an access point; and
a station in communication with the access point, the station having at least two network technology subsystems subject to coexistence interference,
wherein the station selectively uses reverse direction grant (RDG) for communications by network technology subsystems subject to coexistence interference.

2. The system of claim 1 wherein said RDG is subject to time-multiplexing constraints and wherein RDG is not implemented for RDG transmission opportunities that are less than a threshold duration.

3. The system of claim 1 wherein the station adjusts time-multiplexing constraints for network technology subsystems subject to coexistence interference to enable RDG communications.

4. The system of claim 1 wherein the station selectively transmits at least one RDG control bit to the access point to configure the access point for RDG communications.

5. The system of claim 4 wherein the RDG controls bits are transmitted to the access point using a power save (PS)-Poll frame.

6. The system of claim 4 wherein the RDG control bits are transmitted to the access point using a quality of service (QoS)-Null frame.

7. The system of claim 4 wherein the RDG control bits are transmitted to the access point using a data frame.

8. The system of claim 1 wherein the station sets a transmission opportunity (TXOP) duration that ensures the access point, in response to the RDG, has time to transmit an acknowledgement regarding the RDG and at least one MAC protocol data unit (MPDU) before a switch between network technology subsystems subject to coexistence interference.

9. The system of claim 4 wherein, if the station determines that there is insufficient time to transmit the at least one RDG control bit and to receive at least one data packet back from the access point before a mode switch between network technology subsystems subject to coexistence interference, the station does not transmit the at least one RDG control bit.

10. A communication device, comprising:
a transceiver with a first wireless technology subsystem and a second wireless technology subsystem, the first and second wireless technology subsystems being subject to coexistence interference,
wherein, to avoid an avalanche effect, the transceiver comprises arbitration logic that manages reverse direction grant (RDG) requests for communications by at least one of the first and second wireless technology subsystems.

11. The communication device of claim 10 wherein the arbitration logic causes the transceiver to selectively transmit at least one RDG control bit to make an RDG request.

12. The communication device of claim 11 wherein the arbitration logic causes the transceiver to transmit the at least one RDG control bit using a power save (PS)-Poll frame, a quality of service (QoS)-Null frame, or a data frame.

13. The communication device of claim 10 wherein the arbitration logic employs RDG subject to time-multiplexing constraints and wherein RDG is not implemented for RDG transmission opportunities that are less than a threshold duration.

14. The communication device of claim 10 wherein the arbitration logic selectively adjusts time-multiplexing parameters for the first and second wireless technology subsystems to enable RDG communications.

15. The communication device of claim 10 wherein the arbitration logic selectively adjusts network allocation vector (NAV) transmission opportunities (TXOPs) for the first and second wireless technology subsystems to extend RDG communications.

16. The communication device of claim 10 wherein the arbitration logic is implemented by a media access control (MAC) layer of the transceiver.

17. A method, comprising:
providing a transceiver with a first wireless technology subsystem and a second wireless technology subsystem, the first and second wireless technology subsystems being different; and
arbitrating reverse direction grant (RDG) communications for the first and second wireless technology subsystems to avoid an avalanche effect.

18. The method of claim 17 further comprising transmitting at least RDG control bit to configure RDG communications using a power save (PS)-Poll frame, a quality of service (QoS)-Null frame, or a data frame.

19. The method of claim 17 further comprising selecting a transmission opportunity (TXOP) duration to support an RDG request period and an RDG response period before a mode switch occurs between the first and second wireless technology subsystems.

20. The method of claim 16 further comprising avoiding an RDG request if a transmission opportunity (TXOP) duration does not support an RDG request period and an RDG response period before a mode switch occurs between the first and second wireless technology subsystems.
